(19) United States
(12) Patent Application Publication
(10) Pub. No.: US 2009/0111925 A1
(43) Pub. Date: Apr. 30, 2009

(54) THERMAL INTERFACE MATERIALS, METHODS OF PRODUCTION AND USES THEREOF

(76) Inventors: Kikue S. Burnham, San Ramon, CA (US); Wenya Fan, Campbell, CA (US)

Correspondence Address: BUCHALTER NEMER, 18400 VON KARMAN AVE., SUITE 800, IRVINE, CA, 92612, US

(21) Appl. No.: 11/932,094

(22) Filed: Oct. 31, 2007

(51) Int. Cl. C08L 83/04; C08K 5/053

(52) U.S. Cl. 524/394; 524/500; 524/588

(57) ABSTRACT

Thermal interface materials comprise at least one silicon-based polymer and are formed from a combination of at least one silicon-based material, at least one catalyst and at least one elasticity promoter. In some embodiments, contemplated materials are also formed utilizing at least one polymerization component. Thermal interface materials are also disclosed that are capable of withstanding temperatures of at least 250 C where the material comprises at least one silicon-based polymer coupled with at least one elasticity promoter. Methods of forming these thermal interface materials comprise providing each of the at least one silicon-based material, at least one catalyst and at least one elasticity promoter, blending the components and optionally including the at least one polymerization component. Contemplated thermal interface materials disclosed are thermally stable, sticky, and elastic, and show a good thermal conductivity and strong adhesion when deposited on the high thermally conductive material. The thermal interface materials may then be utilized as formed or the materials may be cured pre- or post-application of the thermal interface material to the surface, substrate or component.

### FIELD OF THE SUBJECT MATTER

The field of the subject matter is thermal interface systems and interface materials in electronic components, semiconductor components and other related layered materials applications, especially for burn-in applications, where improved adhesion to metal layers is desired.

### BACKGROUND

Electronic components are used in ever increasing numbers in consumer and commercial electronic products. Examples of some of these consumer and commercial products are televisions, flat panel displays, personal computers, gaming systems, Internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging Products and components also need to be prepackaged, such that the product and/or component can perform several related or unrelated functions and tasks. Examples of some of these “total solution” components and products comprise layered materials, mother boards, cellular and wireless phones and telecommunications devices and other components and products, such as those found in US patent and PCT Application Ser. Nos.: 60/396,294 filed Jul. 15, 2002, 60/294,433 filed May 30, 2001, 10/519,337 filed Dec. 22, 2004, 10/551,305 filed Sep. 28, 2005, 10/465,968 filed Jun. 26, 2003 and PCT/US02/17331 filed May 30, 2002, which are all commonly owned and incorporated herein in their entirety.

Components, therefore, are being broken down and investigated to determine if there are better building materials and methods that will allow them to be scaled down and/or combined to accommodate the demands for smaller electronic components. In layered components, one goal appears to be decreasing the number of the layers while at the same time increasing the functionality and durability of the remaining layers and surface/support materials. This task can be difficult, however, given that several of the layers and components of the layers should generally be present in order to operate the device. In addition, it is also a goal to be able to reuse or recycle materials throughout the process, based on both the desire to control costs and the desire to keep materials as environmentally-conscious as possible.

Also, as electronic devices become smaller and operate at higher speeds, energy emitted in the form of heat increases dramatically with heat flux often exceeding 100 W/cm². A popular practice in the industry is to use thermal grease, or grease-like materials, alone or on a carrier in such devices to transfer the excess heat dissipated across physical interfaces. Most common types of thermal interface materials are thermal greases, phase change materials, and elastomer tapes. Thermal greases or phase change materials have lower thermal resistance than elastomer tape because of the ability to be spread in very thin layers and provide intimate contact between adjacent surfaces. Typical thermal impedance values range between 0.05-1.6° C.-cm²/W. However, a serious drawback of thermal grease is that thermal performance deteriorates significantly after thermal cycling, such as from −65° C. to 150° C., or after power cycling when used in VLSI chips. The most common thermal greases use silicone oils as the carrier. It has also been found that the performance of these materials deteriorates when large deviations from surface planarity causes gaps to form between the mating surfaces in the electronic devices or when large gaps between mating surfaces are present for other reasons, such as manufacturing tolerances, etc When the heat transferability of these materials breaks down, the performance of the electronic device in which they are used is adversely affected.

Components and dies that will fail early could be screened out from the general population of other components and discarded with minimal effort spent packaging and/or servicing faulty components. To this end, a burn-in test is usually done for microprocessors and other high end die. The burn-in process aims to power chips and maintain them at elevated temperatures for an extended period of time to identify and reject substandard chips. Since many failure mechanisms associated with semiconductor die increase exponentially with temperature, most burn-in testing is done at elevated temperatures, which forces failure to occur in a reasonably short time.

While it is desired that the junction temperatures on the component be maintained at a temperature above typical operating temperatures to accelerate failures, high-powered die and components often must be cooled to some extend during the burn-in process to prevent failures that would not have otherwise occurred. The cooling step during burn-in presents a unique set of challenges. Sufficient heat must be withdrawn from the device to prevent unnecessarily high junction temperatures. Since the die are often not fully packaged, the method of withdrawing heat from the die or component must not interfere with downstream packaging efforts. There are several cooling methods available including liquid immersion, liquid spray and air or liquid cooled heat sink attachments. Increasingly, burn-in sockets incorporate an air or liquid cooled heat sink for controlling chip temperature. When a heat sink is used, the question or whether to use a thermal interface, and if so what material, arises. Conventional interface materials, such as grease and phase change materials present problems, such as needing to be cleaned/reapplied with each cycle and are thus not good candidates. Liquids, such as water or dielectrics, need to be reapplied each cycle, but may not need to be cleaned, only heated to drive off the fluid.

Thus, there is a continuing need to: a) design and produce thermal interface materials that have a high thermal and chemical stability for testing applications, such as burn-in testing; b) produce more efficient and better designed materials, products and/or components with respect to the compatibility requirements of the material, component or finished product; c) produce materials and layers that are more compatible with other layers, surfaces and support materials at the interface of those materials; d) develop reliable methods of producing desired thermal interface materials and layered materials and components/products comprising contemplated thermal interface and layered materials; e) develop materials that possess a high thermal conductivity, low thermal impedance, good pot life and a high mechanical compliance; and f) effectively reduce the number of production steps necessary for a package assembly, which in turn results in a lower cost of ownership over other conventional layered materials and processes.

### SUMMARY

Thermal interface materials comprise at least one silicon-based polymer and are formed from a combination of at least one silicon-based material, at least one catalyst and at least one elasticity promoter. In some embodiments, contemplated materials are also formed utilizing at least one polymerization component. Thermal interface materials are also disclosed that are capable of withstanding temperatures of at least 250 C where the material comprises at least one silicon-based polymer coupled with at least one elasticity promoter.

Contemplated thermal interface materials disclosed are thermally stable, sticky, and elastic, and show a good thermal conductivity and strong adhesion when deposited on the high thermally conductive material.

Methods of forming these thermal interface materials comprise providing each of the at least one silicon-based material, at least one catalyst and at least one elasticity promoter, blending the components and optionally including the at least one polymerization component. The thermal interface materials may then be utilized as formed or the materials may be cured pre- or post-application of the thermal interface material to the surface, substrate or component.

### BRIEF DESCRIPTION OF THE FIGURES

FIGS. 1A and 1B shows thermal data (TGA) collected from a contemplated thermal interface material and PCM45F. The thermal interface material was QB-4 (21.8880 mg), and the materials were run on a 2950 TGA V5.4A Instrument.

FIG. 2 shows cycle testing data collected from a contemplated embodiment and an organic phase change material.

FIG. 3 shows cycle testing data collected from a contemplated thermal interface material on an indium surface. The material was painted onto the indium surface and remained sticky after 1000 cycles.

FIG. 4 shows cycle testing data collected from PCM organic material coupled with an indium surface. Significant oxidation was observed on the indium surface.

Table 1 shows contemplated thermal interface material recipes and properties.

Table 2 shows a contemplated thermal interface material compared with PCM45F.

### DETAILED DESCRIPTION

A suitable interface material or component should conform to the mating surfaces (deforms to fill surface contours and “wets” the surface), possess a low bulk thermal resistance and possess a low contact resistance. Bulk thermal resistance can be expressed as a function of the material's or component's thickness, thermal conductivity and area. Contact resistance or thermal impedance is a measure of how well a material or component is able to transfer heat across the interface which is largely determined by the amount and type of contact between the two materials. One of the goals of the materials and methods described herein is to minimize contact resistance without a significant loss of performance from the materials. The thermal resistance of an interface material or component can be shown as follows:

Θinterface t/k+2Θ_{contact} Equation 1
where
   Θ is the thermal resistance,
   t is the material thickness,
   k is the thermal conductivity of the material

The term “t/k” represents the thermal resistance of the bulk material and “2Θ_{contact}” represents the thermal contact resistance at the two surfaces. A suitable interface material or component should have a low bulk resistance and a low contact resistance, i.e. at the mating surface.

Many electronic and semiconductor applications require that the interface material or component accommodate deviations from surface flatness resulting from manufacturing and/or warpage of components because of coefficient of thermal expansion (CTE) mismatches.

A material with a low value for k, such as thermal grease, performs well if the interface is thin, i.e. the “t” value is low. If the interface thickness increases by as little as 0.002 inches, the thermal performance can drop dramatically. Also, for such applications, differences in CTE between the mating components cause the gap to expand and contract due to warpage with each temperature or power cycle. This variation of the interface thickness can cause pumping of fluid interface materials (such as grease) away from the interface.

Interfaces with a larger area are more prone to deviations from surface planarity as manufactured. To optimize thermal performance, the interface material should be able to conform to and adhere to non-planar surfaces and thereby achieve lower contact resistance. As used herein, the term “interface” means a couple or bond that forms the common boundary between two parts of matter or space, such as between two molecules, two backbones, a backbone and a network, two networks, etc. An interface may comprise a physical attachment of two parts of matter or components or a physical attraction between two parts of matter or components, including bond forces such as covalent and ionic bonding, Van der Waals, diffusion bonding, hydrogen bonding and non-bond forces such as electrostatic, coulombic, and/or magnetic attraction. Contemplated interfaces include those interfaces that are formed with bond forces, such as covalent and metallic bonds; however, it should be understood that any suitable adhesive attraction or attachment between the two parts of matter or components is preferred.

Optimal interface materials and/or components possess a high thermal conductivity, a low thermal impedance and a high mechanical compliance, e.g. will yield elastically or plastically at the local level when force is applied. High thermal conductivity reduces the first term of Equation 1 while high mechanical compliance reduces the second term. The layered interface materials and the individual components of the layered interface materials described herein accomplish these goals. When properly produced, the thermal interface component described herein will span the distance between the mating surfaces, thereby allowing a continuous high conductivity path from one surface to the other surface.

As mentioned earlier, several goals of thermal interface materials, layered interface materials and individual components described herein are to: a) design and produce thermal interface materials that have a high thermal and chemical stability for testing applications, such as burn-in testing; b) produce more efficient and better designed materials, products and/or components with respect to the compatibility requirements of the material, component or finished product; c) produce materials and layers that are more compatible with other layers, surfaces and support materials at the interface of those materials; d) develop reliable methods of producing desired thermal interface materials and layered materials and components/products comprising contemplated thermal interface and layered materials; e) develop materials that possess a high thermal conductivity, low thermal impedance, good pot life and a high mechanical compliance; and f) effectively reduce the number of production steps necessary for a package assembly, which in turn results in a lower cost of ownership over other conventional layered materials and processes.

Conventional burn-in materials include organic materials that are applied to surfaces before testing. These organic materials are usually waxes dispersed in an organic polymer materials. These materials have poor thermal stability, which is an inherent property of many organic materials, and they require separate adhesion promoters, because of the wax additive, which is usually a hydrophobic hydrocarbon that exhibits poor adhesion on a hydrophilic metal surface (metal oxide). These conventional materials often have complex chemistries due to the addition of several separate “tuning” components in order to make the material compatible with the metal surface, such as an indium or tin underlayer.

Thermal interface materials that are thermally and chemically stable at high temperatures are provided herein, wherein these materials are especially useful for burn-in applications and may be reusable or recyclable. In addition, thermal solutions and/or IC packages that comprise one or more of these materials and modified surface/support materials described herein are contemplated, ideally, contemplated components of a suite of thermal interface materials exhibit low thermal resistance for a wide variety of interface conditions and demands. Thermal interface materials contemplated herein can be used to attach the heat generating electronic devices (e.g. the computer chip) to the heat dissipating structures (e.g. heat spreaders, heat sinks). The performance of the thermal interface materials is one of the most important factors in ensuring adequate and effective heat transfer in these devices. The thermal interface materials described herein are novel in that they combine components in amounts not yet contemplated or disclosed in other related art. Thermal interface materials that are capable of withstanding temperatures of at least 250 C are contemplated where the material comprises at least one silicon-based polymer coupled with at least one elasticity promoter.

Contemplated and improved thermal interface materials and modified surfaces, as described herein, may be utilized for burn-in testing and applications, along with other thermal or chemical testing methods, but contemplated materials may also be utilized in total solution packaging, such as in a combo-spreader or layered component Contemplated interface materials may be permanent or temporary, in that the material may be included as part of the final component or may be easily peeled away and reused on other components. The layered interface materials and the individual components of the layered interface materials described herein accomplish these goals Contemplated materials are designed to be compatible with metal and metal oxide layers, such as those comprising indium, tin or combinations thereof.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein the phrase “f-block” means those elements that have electrons filling the 4f and 5f orbitals surrounding the nucleus of the element, including the lanthanides and the actinides. Contemplated metals include indium, silver, copper, aluminum, tin, bismuth, lead, gallium and alloys thereof, silver coated copper, and silver coated aluminum, The term “metal” also includes alloys, metal/metal composites, metal ceramic composites, metal polymer composites, as well as other metal composites. As used herein, the term “compound” means a substance with constant composition that can be broken down into elements by chemical processes. As used herein, the phrase “metal-based” refers to any coating, film, composition or compound that comprises at least one metal.

Thermal interface materials comprise at least one silicon-based polymer and an elasticity promoter and are formed from a combination of at least one silicon-based material, at least one catalyst and at least one elasticity promoter. In some embodiments, contemplated materials are also formed utilizing at least one polymerization component. Methods of forming these thermal interface materials comprise providing each of the at least one silicon-based material, at least one catalyst and at least one elasticity promoter, blending the components and optionally including the at least one polymerization component. The thermal interface materials may then be utilized as formed or the materials may be cured pre- or post-application of the thermal interface material to the surface, substrate or component.

Contemplated interface materials comprise similar properties to PCM45, which has a thermal conductivity of about 3.0 W/m-K, a thermal resistance of about 0.25° C.-cm²/W at 0.05 mm thickness, is typically applied at a thickness of about 0.010 inches (0.254 mm) and comprises a soft material above the phase change temperature of approximately 45° C., flowing easily under an applied pressure of about 5 to 30 psi. Typical characteristics of PCM45 are a) a super high packaging density—over 80 weight %, b) a conductive filler, c) extremely low thermal resistance, and as mentioned earlier d) about a 45° C. phase change temperature.

As mentioned, contemplated thermal interface materials are formed from at least one silicon-based material or polymer. It is important to include the silicon-oxygen bond throughout the silicon-based material or polymer, because the presence of the Si—O bonds give the materials an “ionic nature” that contributes to the thermal and chemical stability of the thermal interface material, along with helping to control the crosslinking in the material. Examples of silicon-based materials comprise siloxane compounds, such as methylsiloxane, methylsilsesquioxane, phenylsiloxane, phenylsilsesquioxane, methylphenylsiloxane, methylphenylsilsesquioxane, silazane polymers, dimethylsiloxane, diphenylsiloxane, methylphenylsiloxane, silicate polymers, silsilic acid derivaties, and mixtures thereof. In some contemplated embodiments, the silicon-based materials or polymers comprise vinyl-terminated or hydride-terminated siloxanes, such as vinyl-terminated polydimethyl siloxane or hydride-terminated polydimethyl siloxane. In addition, silicon-based compounds include copolymers, such as methylhydrisiloxane-dimethylsiloxane copolymer and vinylmethylsiloxane-dimethylsiloxane, which are silanol terminated (4-8% OH).

As used herein, silicon-based materials or polymers also include siloxane polymers and blockpolymers, hydrogensiloxane polymers of the general formula (H_{0-1.0}SiO_{1.5-2.0})ₓ, hydrogensilsesquioxane polymers, which have the formula (HSiO_{1.5})ₓ where x is greater than about four and derivatives of silsilic acid. Also included are copolymers of hydrogensilsesquioxane and an alkoxyhydridosiloxane or hydroxyhydridosiloxane. Materials contemplated herein additionally include organosiloxane polymers, acrylic siloxane polymers, silsesquioxane-based polymers, derivatives of silici acid, organohydridosiloxane polymers of the general formula (H_{0-1.0}SiO_{1.5-2.0})ₙ)(R_{0-1.0}SiO_{1.5-2.0})ₘ, and organohydridosilsesquioxane polymers of the general formula (HSiO_{1.5})ₙ(RSiO_{1.5})ₘ, where m is greater than zero and the sum of n and m is greater than about four and R is alkyl or aryl. Some useful organohydridosiloxane polymers have the sum of n and m from about four to about 5000 where R is a C₁-C₂₀ alkyl group or a C₆-C₁₂ aryl group. Some specific examples include alkylhydridosiloxanes, such as methylhydridosiloxanes, ethylhydridosiloxanes, propylhydridosiloxanes, t-butylhydridosiloxanes, phenylhydridosiloxanes; and alkylhydridosiisesquioxanes, such as methylhydridosilsesquioxanes, ethylhydridosilsesquioxanes, propylhydridosilsesquioxanes, t-butylhydridosilsequioxanes, phenylhydridosilsesquioxanes, and combinations thereof. In some contemplated embodiments, siloxane polymers comprise vinyl-terminated polydimethyl siloxane, hydride-terminated polydimethyl siloxane, methylhydrisiloxane-dimethylsiloxane copolymer, vinylmethylsiloxane-dimethylsiloxane copolymer or a combination thereof. In some contemplated embodiments, specific organohydridosiloxane polymers utilized herein have the following general formulas:

[H—Si_{1.5}]ₙ[R—SiO_{1.5}]ₘ Formula (1)

[H_{0.5}—Si_{1.5-1.8}]ₙ[R_{0.5-1.0}—SiO_{1.5-1.8}]ₘ Formula (2)

[H_{1-1.0}—Si_{1.5}]ₙ[R—SiO_{1.5}]ₘ Formula (3)

[H—Si_{1.5}]ₓ[R—SiO_{1.5}]_{y}[SiO₂]_{z} Formula (4)

wherein:
the sum of n and m, or the sum or x, y and z is from about 8 to about 5000, and m or y is selected such that carbon containing constituents are present in either an amount of less than about 40 percent (Low Organic Content=LOSP) or in an amount greater than about 40 percent (High Organic Content HOSP); R is selected from substituted and unsubstituted, normal and branched alkyls (methyl, ethyl, butyl, propyl, pentyl), alkenyl groups (vinyl, allyl, isopropenyl), cycloalkyls, cycloalkenyl groups, aryls (phenyl groups, benzyl groups, naphthalenyl groups, anthracenyl groups and phenanthrenyl groups), and mixtures thereof; and wherein the specific mole percent of carbon containing substituents is a function of the ratio of the amounts of starting materials. In some LOSP embodiments, particularly favorable results are obtained with the mole percent of carbon containing substituents being in the range of between about 15 mole percent to about 25 mole percent. In some HOSP embodiments, favorable results are obtained with the mole percent of carbon containing substituents are in the range of between about 55 mole percent to about 75 mole percent.

Some of the contemplated compounds previously mentioned are taught by commonly assigned U.S. Pat. No. 6,143,855 and pending U.S. Ser. No. 10/078,919 filed Feb. 19, 2002; Honeywell International Inc.'s commercially available HOSP® product; nanoporous silica such as taught by commonly assigned U.S. Pat. No. 6,372,666; Honeywell International Inc.'s commercially available NANOGLASS®E product; organosilsesquioxanes taught by commonly assigned WO 01/29052; and fluorosilsesquioxanes taught by commonly assigned U.S. Pat. No. 6,440,550, incorporated herein in their entirety. Other contemplated compounds are described in the following issued patents and pending applications, which are herein incorporated by reference in their entirety: (PCT/US00/15772 filed Jun. 8, 2000; U.S. application Ser. No. 09/330,248 filed Jun. 10, 1999; U.S. application Ser. No. 09/491,166 filed Jun. 10, 1999; U.S. Pat. No. 6,365,765 issued on Apr. 2, 2002; U.S. Pat. No. 6,268,457 issued on Jul. 31, 2001; U.S. application Ser. No. 10/001,143 filed Nov. 10, 2001; U.S. application Ser. No. 09/491,166 filed Jan. 26, 2000; PCT/US00/00523 filed Jan. 7, 1999; U.S. Pat. No. 6,177,199 issued Jan. 23, 2001; U.S. Pat. No. 6,358,559 issued Mar. 19, 2002; U.S. Pat. No. 6,218,020 issued Apr. 17, 2001; U.S. Pat. No. 6,361,820 issued Mar. 26, 2002; U.S. Pat. No. 6,218,497 issued Apr. 17, 2001; U.S. Pat. No. 6,359,099 issued Mar. 19, 2002; U.S. Pat. No. 6,143,855 issued Nov. 7, 2000; U.S. application Ser. No. 09/611,528 filed Mar. 20, 1998; and U.S. Application Ser. No. 60/043,261) Silica compounds contemplated herein are those compounds found in U.S. Pat. Nos.: 6,022,812; 6,037,275; 6,042,994; 6,048,804; 6,090,448; 6,126,733; 6,140,254; 6,204,202; 6,208,041; 6,318,124 and 6,319,855.

The silicon-based compounds may comprise polymers, pre-polymers or combinations thereof. As used herein, the term “pre-polymer” refers to any chemical compound that is capable of forming a covalent bond with itself or a chemically different compound in a repetitive manner. The repetitive bond formation between pre-polymers may lead to a linear, branched, super-branched, or three-dimensional product. Furthermore, pre-polymers may themselves comprise repetitive building blocks, and when polymerized the polymers formed from such prepolymers are then termed “blockpolymers”. Pre-polymers may belong to various chemical classes of molecules including organic, organometallic or inorganic molecules. The molecular weight of pre-polymers may vary greatly between about 40 Dalton and 20000 Dalton. However, especially when pre-polymers comprise repetitive building blocks, pre-polymers may have even higher molecular weights. Pre-polymers may also include additional groups, such as groups used for crosslinking. Several contemplated polymers comprise a polymer backbone encompassing alternate silicon and oxygen atoms; A contemplated reduced amount of the catalyst and the crosslinker prevent the unwanted chain lengthening and cross-linking. As a result, the pot life and shelf life of these materials are greatly enhanced, as described throughout this disclosure.

In some contemplated embodiments, silicon-based materials comprise at least two silicon-based polymers. In these embodiments, the crosslinking density can be controlled or optimized by adjusting the molar ratios of the at least two silicon-based polymers with respect to one another. As mentioned throughout the disclosure, the crosslinking density is directly related to the stickiness of the material.

In some embodiments, at least one polymerization component is included in the formulation to produce contemplated thermal interface materials. These polymerization components are designed to facilitate the formation of block polymers. For example, a contemplated polymerization component comprises polycaprolactone diol.

Contemplated silicon-based thermal interface materials are also produced by utilizing at least one catalyst, such as a platinum catalyst. As used herein, the term “catalyst” means any substance that affects the rate of the chemical reaction by lowering the activation energy for the chemical reaction. In some cases, the catalyst will lower the activation energy of a chemical reaction without itself being consumed or undergoing a chemical change.

As mentioned above, contemplated silicon-based thermal interface materials are also produced using at least one elasticity promoter. As used herein, an “elasticity promoter” is a compound that can either be chemically bonded to the thermal interface material or blended with the thermal interface material in order to increase the elasticity of the thermal interface material. In contemplated embodiments, the elasticity promoter is reacting with the silicon-based compound. This increased elasticity in the thermal interface material gives it a “sticky” quality, in that it becomes very sticky with the attached metal or metal oxide. It is this sticky quality of the thermal interface material that makes it especially compatible with coupled metal surfaces that would otherwise be problematic for conventional thermal interface materials. In some embodiments, elasticity promoters include polypropylene glycol.

Contemplated thermal interface materials may also comprise phase change materials, such as those produced by Honeywell International Inc. and those mentioned herein. In some contemplated embodiments, polycaprolactone diol can be used as either a phase change material like wax or polymerization component in combination with polypropylene glycol. When it is used as the former, it can be added into the OB-4 formulation, as shown in Table 1 of Example 1. The addition of polycaprolactone diol as a phase change material is demonstrated by the formulations QB-7 and QB-8 shown in Table 1.

The contemplated thermal interface component can be provided as a dispensable paste to be applied by dispensing methods (such as screen printing, stencil printing, or automated dispensing) and then cured as desired. It can also be provided as a highly compliant, cured, elastomer film or sheet for pre-application on interface surfaces, such as heat sinks. It can further be provided and produced as a soft gel or liquid that can be applied to surfaces by any suitable dispensing method, such as screen-printing or ink jet printing. Even further, the thermal interface component can be provided as a tape that can be applied directly to interface surfaces or electronic components. As mentioned, it can be removed after use and reapplied to another surface or recycled. Contemplated thermal interface materials are designed to be thermally stable up to 250 C.

Thermal interface materials and related layers can be laid down in any suitable thickness, depending on the needs of the electronic component, and the vendor as long as the thermal interface component is able to sufficiently perform the task of dissipating some or all of the heat generated from the surrounding electronic component. Contemplated thicknesses comprise thicknesses in the range of about 0.050-0,100 mm. In some embodiments, contemplated thicknesses of thermal interface materials are within the range of about 0.030-0.150 mm. In other embodiments, contemplated thicknesses of thermal interface materials are within the range of about 0.010-250 mm.

In some contemplated embodiments, thermal interface material can be directly deposited onto at least one of the sides of the component such as the bottom side, the top side or both. In some contemplated embodiments, the thermal interface material is silk screened, stencil printed, screen printed or dispensed directly onto the component by methods such as jetting, thermal spray, liquid molding or powder spray. In yet other contemplated embodiments, a film of thermal interface material is deposited and combined with other methods of building adequate thermal interface material thickness, including direct attachment of a preform or silk screening of a thermal interface material paste.

Methods of forming layered thermal interface materials and thermal transfer materials include: a) providing a component, wherein the component comprises a top surface, a bottom surface and at least one heat spreader material; b) providing at least one thermal interface material, such as those described herein, wherein the thermal interface material is directly deposited onto the bottom surface of the component; c) depositing, applying or coating the at least one thermal interface material onto at least part of at least one of the surfaces of the component, and e) bringing the bottom of the component with the thermal interface material into contact with the heat generating device, generally a semiconductor die. Once deposited, applied or coated, the thermal interlace material layer comprises a portion that is directly coupled to the heat spreader material and a portion that is exposed to the atmosphere, or covered by a protective layer or film that can be removed just prior to installation of the component.

As described herein, optimal interface materials and/or components possess a high thermal conductivity and a high mechanical compliance, e.g. will yield elastically or plastically on a local level when force is applied. In some embodiments, optimal interface materials and/or components will possess a high thermal conductivity and good gap-filling properties. High thermal conductivity reduces the first term of Equation 1 while high mechanical compliance reduces the second term. The layered interface materials and the individual components of the layered interlace materials described herein accomplish these goals. When properly produced, the thermal interface component described herein will span the distance between the mating surfaces of the heat producing device and the heat spreader component thereby allowing a continuous high conductivity path from one surface to the other surface. Suitable thermal interface components comprise those materials that can conform to the mating surfaces, possess a low bulk thermal resistance and possess a low contact resistance.

Contemplated thermal interface materials, along with layered thermal interface materials and components may then be applied to a substrate, another surface, or another layered material. The electronic component may comprise, for example, a thermal interface material, a substrate layer and an additional layer. Substrates contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimide. The “substrate” may even be defined as another polymer material when considering cohesive interfaces.

Additional layers of material may be coupled to the thermal interface materials or layered interface materials in order to continue building a layered component or printed circuit board. It is contemplated that the additional layers will comprise materials similar to those already described herein, including metals, metal alloys, composite materials, polymers, monomers, organic compounds, inorganic compounds, organometallic compounds, resins, adhesives and optical wave-guide materials.

Applications of the contemplated thermal solutions, IC packages, thermal interface components, layered interface materials and heat spreader components described herein comprise incorporating the materials and/or components into another layered material, an electronic component or a finished electronic product. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

### EXAMPLES

### Example 1

### Comparison of Contemplated Thermal Interface Materials v. Phase Change Material

### Tables 1 and 2

### Experimental Section

### Materials.

Vinyl-terminated polydimethysiloxane (DMS-V22, molecular weight of 9400)

Hydride-terminated polydimethylsiloxane (DMS-H21, molecular weight of 6000)

Methylhydrisiloxane-dimethylsiloxane Copolymers

Trimethylsiloxy-terminated (HMS-501)

Platinum carbonyl cyclovinylmethylsiloxane complex (SIP6829.2)

Vinylmethylsiloxane-dimethylsiloxane copolymer, silanol terminated 4-8% OH (VDS2513) were purchased from Gelest.

Polypropylene glycol (molecular weight of 2000), and poly poly-caprolactone diol (molecular weight of 1250) were purchased from Aldrich.

All chemicals were used as received.

### Preparation of Resin Mixture and Curing.

A mixture of DMS-V22, DMS-H21, HMS-501, VDS2513, polypropylene glycol were vigorously stirred in a beaker with the specified amount listed in the table. Then platinum catalyst was added to the mixture and stirred. The mixture was cast as films onto silicon wafer, and cured at 150 C for 8 min in air The resulting film (OB-4) was a transparent, extremely sticky, highly elastic, and removed from the plate for analysis for thermal stability,

### Preparation of Burn-in Sample for Mechanical Load Cycling.

Films of QB-4 were prepared by either casting toluene solutions of the mixture listed in Table 1 or its neat mixture on metal substrate such as indium, nickel, and tin, followed by curing at 130 C for 8 min in air.

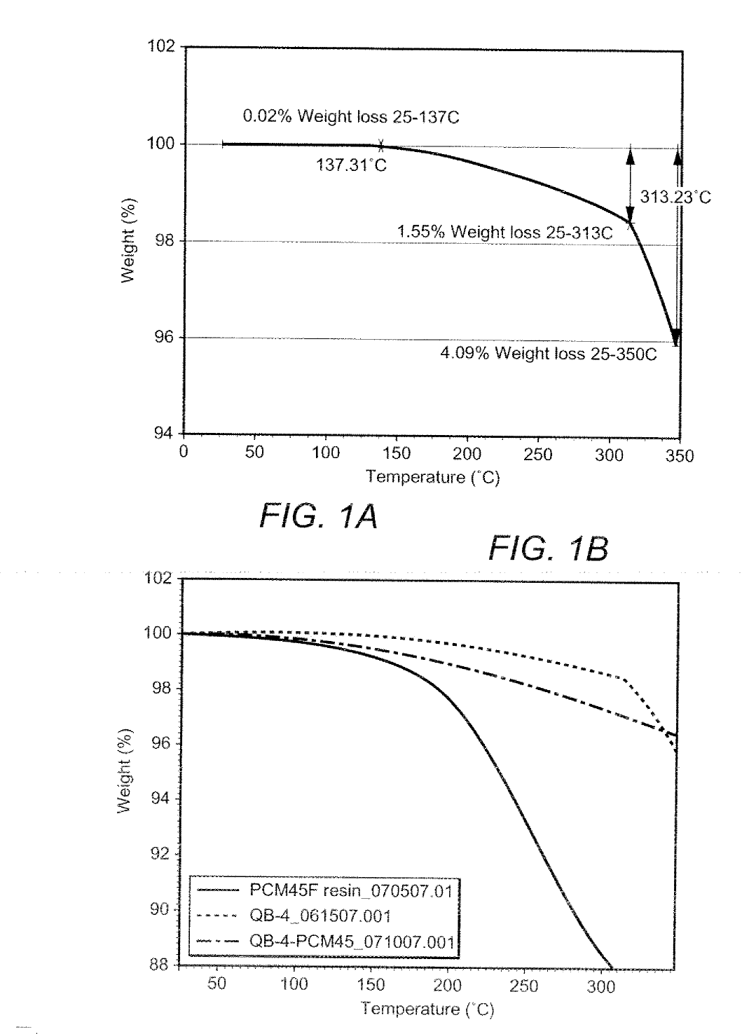

The thermal stability of cured QB-4 and PCM45F was studied by thermal gravimetric analysis (TGA) under nitrogen atmosphere. The weight loss was only 0.1% up to 200° C., 0.7% up to 250° C., and 1% up to 300° C. for OB-4 as shown in FIGS. 1A and 1B. In contrast, the weight loss of PCM4SF was 3% up to 200° C., 7% up to 250° C., and 11.5% up to 300° C. This higher thermal stability of the former is indicative of more cross-linked structure and inherently strong Si—O polymer chains, as opposed to a lower cross-linked structure and weaker organic polymer chain of latter.

In addition to good thermal stability, the cured films should exhibit a good adhesion toward the metal surface of interest to be useful as burn-in material. Adhesion of QB-4 toward metal surface such as indium, nickel, and tin was assessed by comparing the stickiness of the cured material on the substrate after curing and (or) the mechanical load cycling. It was found that QB-4 maintained the same initial stickiness even after 6 weeks at room temperature and after even 1000 cyclings, whereas, PCM45F became little brittle due to hydrophobic nature of the wax material. The high stickiness of QB-4 was attributed to an optimized crosslinking degree. The crosslinking degree was controlled by adjusting the amount of the catalyst, vinyl and SiH, polypropylene glycol, and Si—OH group, as shown in Table 1. A pot life of the cured OB-4 film was excellent, no degradation at room temperature was observed for more than 2-3 months.

### Example 2

### Comparison of Conventional Burn-In Cycle Versus Contemplated Burn-In Cycle

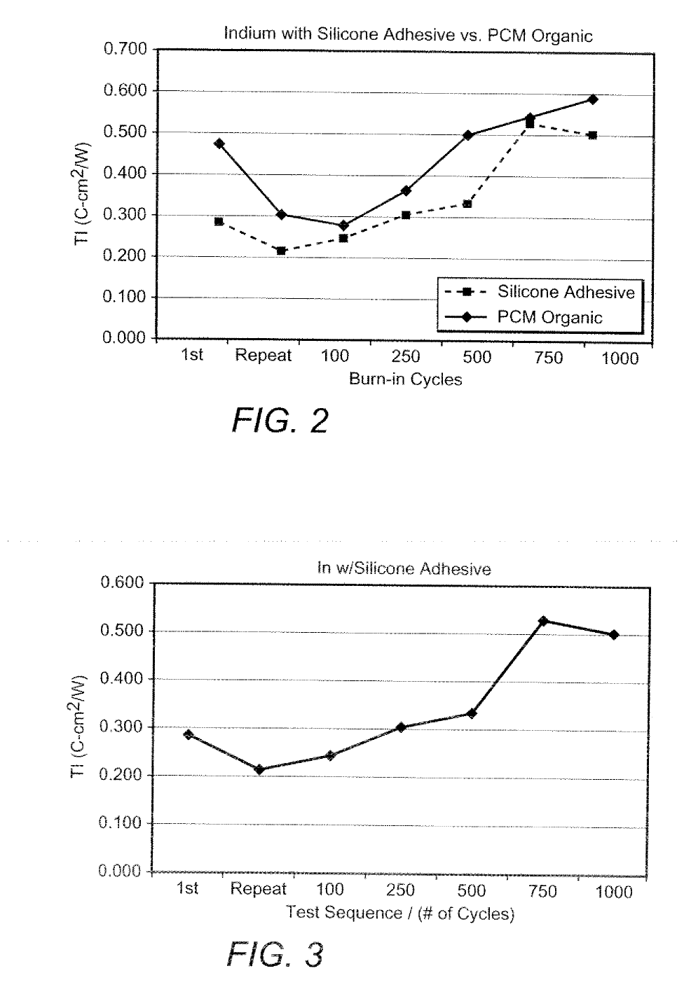

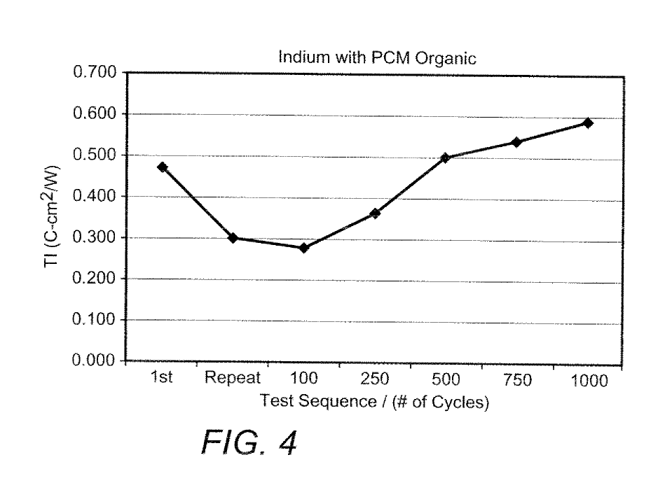

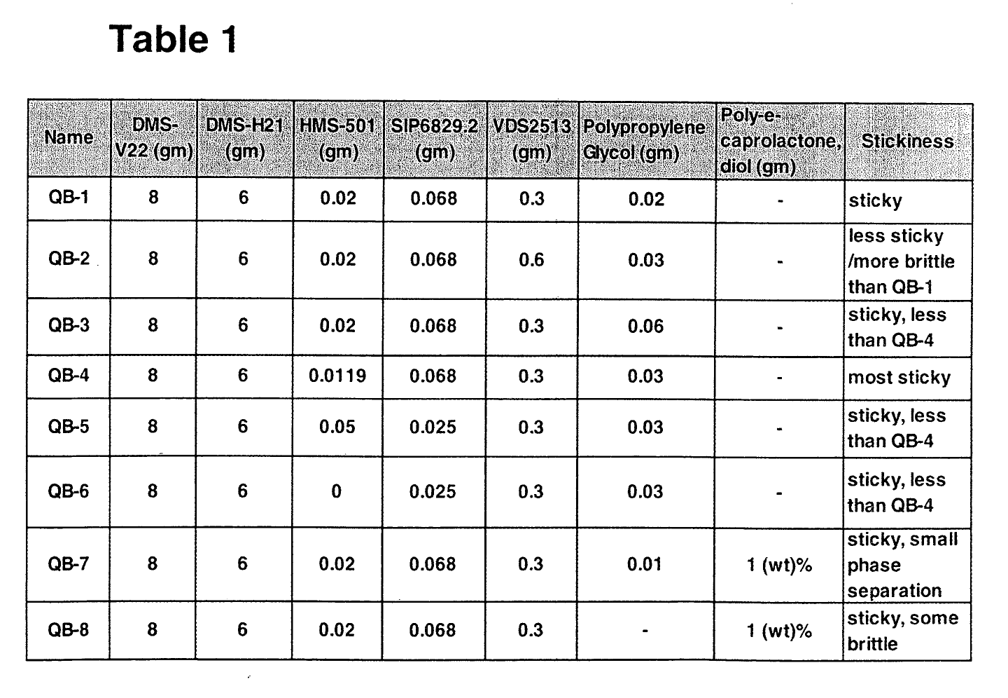

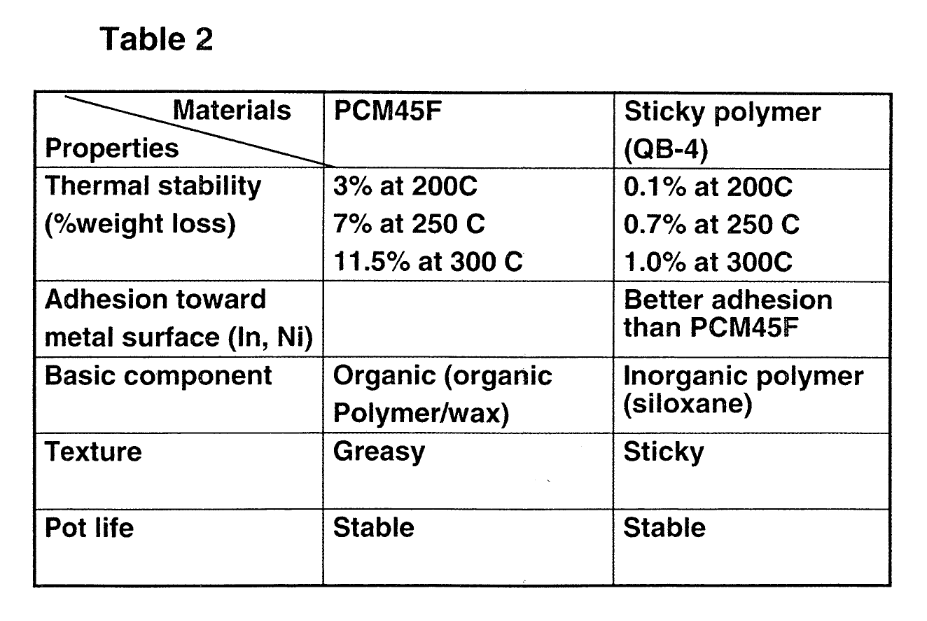

To assess thermal performance of the QB-4 material from Example 1 on indium and tin substrates, the cured material on either substrate was subjected to the mechanical cycling at the pressure of 25-30 psi, at 130 C of the heater block surface, burn-in contracts for 10 seconds, off for 10 seconds (for 1 cycle) for 1000 cycles. The thermal impedance of QB-4 was comparable with that of PCM45F or slightly better. The sudden increase in thermal impedance after 500 cycles were due to a heavy oxidation of the indium surface, not directly related to the material properties of CB-4. The results of these tests are shown in FIGS. 2-4.

Thus, specific embodiments and applications of thermal interface materials have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A thermal interface material capable of withstanding temperatures of at least 250 C, the material comprising at least one silicon-based polymer coupled with at least one elasticity promoter.

2. The thermal interface material of claim 1, wherein the at least one silicon-based polymer comprises at least one siloxane polymer.

3. The thermal interface material of claim 2, wherein the at least one siloxane polymer comprises a vinyl-terminated polydimethyl siloxane, hydride-terminated polydimethyl siloxane, methylhydrisiloxane-dimethylsiloxane copolymer, vinylmethylsiloxane-dimethylsiloxane copolymer or a combination thereof.

4. The thermal interface material of claim 1 wherein the at least one elasticity promoter comprises polypropylene glycol.

5. A thermal interface material capable of withstanding temperatures of at least 250 C, wherein the material is formed from a combination of at least one silicon-based material, at least one catalyst and at least one elasticity promoter.

6. The thermal interface material of claim 5, wherein the at least one silicon-based polymer comprises at least one siloxane polymer.

7. The thermal interface material of claim 6, wherein the at least one siloxane polymer comprises a vinyl-terminated polydimethyl siloxane, hydride-terminated polydimethyl siloxane, methylhydrisiloxane-dimethylsiloxane copolymer, vinylmethylsiloxane-dimethylsiloxane copolymer or a combination thereof.

8. The thermal interface material of claim 5, wherein the at least one elasticity promoter comprises polypropylene glycol.

9. The thermal interface material of claim 5, wherein the at least one catalyst comprises a platinum catalyst.

10. The thermal interface material of claim 5, further comprising providing at least one polymerization component and blending the component with the at least one silicon-based material, at least one catalyst and at least one elasticity promoter.

11. The thermal interface material of claim 10, wherein the at least one polymerization component comprises polycaprolactone diol.

12. The thermal interface material of claim 1, further comprising a phase change material.

13. The thermal interface material of claim 12, wherein the phase change material comprises polycaprolactone diol.

14. The thermal interface material of claim 13, further comprising polypropylene glycol.

15. The thermal interface material of claim 1, wherein the material comprises at least two silicon-based polymers.

16. The thermal interface material of claim 15, wherein a crosslinking density of the material is optimized by adjusting the molar ratios of the at least two silicon-based polymers with respect to each other.

17. The thermal interface material of claim 16, wherein the crosslinking density is directly related to the stickiness of the material.

18. A method of forming an thermal interface material, comprising:
providing each of the at least one silicon-based material, at least one catalyst and at least one elasticity promoter,
blending the components, and
optionally including the at least one polymerization component.

19. The method of claim 18, wherein the at least one silicon-based material comprises at least one siloxane polymer.

20. The method of claim 19, wherein the at least one siloxane polymer comprises a vinyl-terminated polydimethyl siloxane, hydride-terminated polydimethyl siloxane, methylhydrisiloxane-dimethylsiloxane copolymer, vinylmethylsiloxane-dimethylsiloxane copolymer or a combination thereof.

21. The method of claim 18, wherein the at least one elasticity promoter comprises polypropylene glycol.

22. The method of claim 18, wherein the material comprises at least two silicon-based polymers.

23. The method of claim 22, wherein a crosslinking density of the material is optimized by adjusting the molar ratios of the at least two silicon-based polymers with respect to each other.
